(19) United States
(12) Patent Application Publication
(10) Pub. No.: US 2022/0118669 A1
(43) Pub. Date: Apr. 21, 2022

(54) COEXTRUDED POLYMERIC NETTING AND METHOD OF MAKING THE SAME

(71) Applicant: 3M INNOVATIVE PROPERTIES COMPANY, St. Paul, MN (US)

(72) Inventors: Ronald W. Ausen, St. Paul, MN (US); William J. Kopecky, Hudson, WI (US); Michael W. Voigt, Crystal, MN (US); Naimul Karim, Maplewood, MN (US); Vasav Sahni, St. Paul, MN (US)

(21) Appl. No.: 17/310,665

(22) PCT Filed: Mar. 3, 2020
(86) PCT No.: PCT/IB2020/051800

§ 371 Date: Aug. 17, 2021

Related U.S. Application Data
(60) Provisional application No. 62/816,283, filed on Mar. 11, 2019.

(51) Int. Cl. B29C 48/18; B29C 48/00

(52) U.S. Cl. CPC B29C 48/18; B29D 28/00; B29C 48/022

(57) ABSTRACT

Coextruded polymeric netting having a machine direction comprising: a plurality of pairs of: first segments each having first and second opposed major surfaces and a thickness, the first segments comprising first material; second segments comprising second material, wherein adjacent first segments are joined together via a second segment, wherein the second segments extend from the second major surface past the first major surface of each first adjacent segment and has a distal end, the second segments having first and second opposed major surfaces, wherein there is a gap between adjacent second segments; and a third material, different from the first and second materials on at least one of the first or second major surfaces of at least every other second segment, wherein the first segments, second segments, and third material each extend continuously for at least 5 mm in the machine direction, and wherein first and second materials of adjacent pairs are periodically bonded together in the machine direction. Uses for coextended polymeric articles described herein include fasteners.

### BACKGROUND

Coextruded polymeric articles (including layers) having projections are known in the art. For example, it is known to provide a co-extruded, layer structures where the layer is partitioned, not as coextensive layers in the thickness direction, but as stripes or segments along the width dimension of the layer. This has sometimes been called “side-by-side” co-extrusion.

There is a desire for additional polymeric articles with projections that offer different configurations and/or properties (e.g., adhesive properties) over conventional articles. Some adhesive systems that switch from a state of relatively low or no adhesion to a state of much higher adhesion upon application of a certain trigger (commonly called “adhesion on demand” systems) are known. Many of these systems use triggers such as solvents, ultra violet light, heat, or magnetic forces, to create tiered adhesive performance once or repetitively. These systems are limited in applications for several reasons. For many of these triggers, the adhesive system must contain specific chemical groups, which restricts usage to applications where those chemical groups can be tolerated. These systems can be used only where a particular trigger is available and can be effectively applied to the adhesive system. Further, some triggers are difficult or inconvenient for consumers to use. Certain triggers, as well as the chemical groups in the adhesive that respond to such triggers, can be cost-prohibitive.

There is a continuing desire for new coextruded polymeric article constructions. Further, there is a need for “adhesion on demand” systems where the trigger is applicable to all adhesive chemistries, the trigger is more broadly or even universally available, the trigger is easy to apply, not only industrially, but by a consumer, and the adhesion-on-demand system is not exceedingly expensive.

### SUMMARY

In one aspect, the present disclosure describes a coextruded polymeric netting having a machine direction comprising:

a plurality of pairs (in some embodiments, at least 3, 4, 5, 10, 25, 50, 100, 250, 500, 750, or even at least 1000 pairs) of:
first segments each having first and second opposed major surfaces and a thickness, the first segments comprising first material;
second segments comprising second material, wherein adjacent first segments are joined together via a second segment, wherein the second segments extend from the second major surface past the first major surface of each first adjacent segment and has a distal end, the second segments having first and second opposed major surfaces, wherein there is a gap between adjacent second segments; and
a third material, different from the first and second materials on at least one of the first or second major surfaces (in some embodiments, on both the first and second major surfaces) of at least every other (in some embodiments, on each) second segment,
   wherein the first segments, second segments, and third material each extend continuously for at least 5 mm in the machine direction (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m), and wherein first and second materials of adjacent pairs are periodically bonded together in the machine direction. “Different” as used herein means at least one of (a) a difference of at least 2% in at least one infrared peak, (b) a difference of at least 2% in at least one nuclear magnetic resonance peak, (c) a difference of at least 2% in the number average molecular weight, or (d) a difference of at least 5% in polydispersity. Examples of differences in polymeric materials that can provide the difference between polymeric materials include composition, microstructure, color, and refractive index. The term “same” in terms of polymeric materials means not different.

In some embodiments, the first segment has first and second opposed major surfaces, wherein the second segment extends past both the first and second surfaces of the first segment, and wherein the third material is on at least one of the first or second major surfaces (in some embodiments, on both the first and second major surfaces) of the second segment both above and below the first segment.

In another aspect, the present disclosure describes a method of making a coextruded polymeric netting described herein, the method comprising:

providing an extrusion die comprising of at least three cavities, a dispensing surface, and fluid passageways between the at least three cavities and the dispensing surface, wherein the dispensing surface has an array of first dispensing orifices separated by an array of second dispensing orifices, wherein the first and second dispensing orifices each have a height and a width, and wherein the height of the second dispensing orifices is at least two times larger than the height of the first dispensing orifices, and wherein the second dispensing orifices comprises a first plurality of a repeating sequence of shims that together provide a fluid passageway between the third cavity and the third orifice, a second plurality of shims that provides a spacer section, and a third plurality of a repeating sequence of shims that together provide a fluid passageway between the second cavity and a second orifice and;

dispensing polymeric ribbons from the second dispensing orifices at a first speed while simultaneously dispensing polymeric segments from the first dispensing orifices at a second speed to provide the polymeric netting, wherein the second speed is at least twice the first speed.

Netting described herein are useful, for example, in fastener systems (e.g., a fastener system comprising at least one netting described herein).

In another aspect, the present disclosure describes an article comprising first and second coextruded polymeric nettings described herein, wherein a portion of some of the first segments of the first coextruded polymeric netting are engaged between some adjacent first segments of the second coextruded polymeric netting. In some embodiments, the engaged first and second coextruded polymeric nettings are the same netting.

Netting described herein are useful, for example, for tape landing zones (e.g., in medical applications where the netting is wrapped around an appendage and attached to itself to provide a medical tape landing zone without adhesion to skin), bundling applications where it is desired to maintain breathability without an air tight barrier such as what happens with elastomeric thin film wraps, and bundling applications where it is desired to have compression wrap without adhesion to the wrapped substrate.

### BRIEF DESCRIPTION OF THE DRAWINGS

FIG. 1 is a perspective view of an exemplary coextruded polymeric article described herein.

FIG. 1A is a perspective view of a portion of the exemplary coextruded polymeric article described herein shown in FIG. 1.

FIG. 2 is a perspective view of another exemplary coextruded polymeric article described herein.

FIG. 2A is a perspective view of a portion of the exemplary coextruded polymeric article shown in FIG. 2.

FIG. 3 is a schematic cross-sectional view of two exemplary coextruded polymeric articles (i.e., a first and a second) shown in FIG. 2, wherein a portion of some of the second segments of the first coextruded polymeric netting are engaged between some adjacent second segments of the second coextruded polymeric netting.

FIG. 4 is a schematic cross-sectional view of an exemplary die cavity pattern just upstream from the dispensing slot of the die employed in the formation of an exemplary coextruded polymeric article described herein.

FIG. 5A is a plan view of an exemplary embodiment of a shim suited to form a sequence of shims capable of forming an exemplary coextruded polymeric article, for example, as shown in FIG. 1.

FIG. 5B is an expanded region near the dispensing surface of the shim shown in FIG. 5A.

FIG. 6A is a plan view of an exemplary embodiment of a shim suited to form a sequence of shims capable of forming a coextruded polymeric article, for example, as shown in FIG. 1.

FIG. 6B is an expanded region near the dispensing surface of the shim shown in FIG. 6A.

FIG. 7A is a plan view of an exemplary embodiment of a shim suited to form a sequence of shims capable of forming a coextruded polymeric article, for example, as shown in FIG. 1.

FIG. 7B is an expanded region near the dispensing surface of the shim shown in FIG. 7A.

FIG. 8A is a plan view of an exemplary embodiment of a shim suited to form a sequence of shims capable of forming a coextruded polymeric article, for example, as shown in FIG. 1.

FIG. 8B is an expanded region near the dispensing surface of the shim shown in FIG. 8A.

FIG. 9A is a plan view of an exemplary embodiment of a shim suited to form a sequence of shims capable of forming a coextruded polymeric article, for example, as shown in FIG. 1.

FIG. 9B is an expanded region near the dispensing surface of the shim shown in FIG. 9A.

FIG. 10A is a plan view of an exemplary embodiment of a shim suited to form a sequence of shims capable of forming a coextruded polymeric article, for example, as shown in FIG. 2.

FIG. 10B is an expanded region near the dispensing surface of the shim shown in FIG. 10A.

FIG. 11 is a perspective assembly drawing of several different exemplary sequences of shims employing the shims of FIGS. 5A, 6A, 7A, 8A, 9A, and 10A for making exemplary coextruded polymeric articles described herein, segments and protrusions in a repeating arrangement as shown in FIG. 1.

FIG. 12 is a perspective view of the some of the sequence of shims of FIG. 11, further exploded to reveal some individual shims.

FIG. 13 is an exploded perspective view of an example of a mount suitable for an extrusion die composed of multiple repeats of the sequence of shims of FIG. 11.

FIG. 14 is a perspective view of the mount of FIG. 13 in an assembled state.

FIG. 15 is an optical image of the Example article.

### DETAILED DESCRIPTION

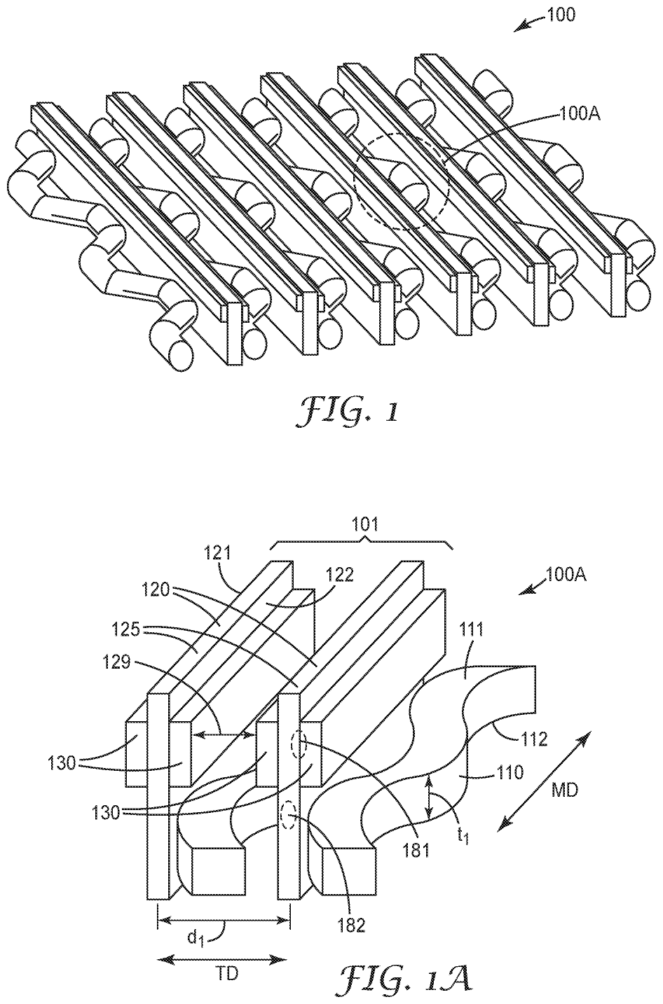

Referring to FIGS. 1 and 1A, exemplary coextruded polymeric netting described herein 100 (and portion thereof 100A) having a machine direction MD and transverse direction TD. Coextruded polymeric netting 100 comprising plurality of pairs 101 of first segments 110 comprising first material, second segments 120 comprising second material, and a third material 130, different from the first and second materials. First segments 110 each have first and second opposed major surfaces 111, 112 and thickness t₁. Adjacent first segments 110 are joined together via second segment 120. Second segments 120 extend from second major surface 112 past first major surface 111 of each first adjacent segment 110 and has distal end 125. Second segments 120 have first and second opposed major surfaces 121, 122. There is gap 129 between adjacent second segments 120. Third material 130 is on at least one of first or second major surfaces 121, 122 (as shown on both the first and second major surfaces 121, 122) of at least every other (as shown on each) second segment 120. First segments 110, second segments 120, and third material 130 each extend continuously for at least 5 mm in the machine direction. First and second materials of adjacent pairs 101 are periodically bonded together in machine direction MD. Distance d₁ is the repeating distance between second segments and can be used to calculate the second segments per centimeter. Region 1₁ with demarcation between adhesive and second segments is shown as reference 181. Region 2₁ without demarcation is shown as reference 182.

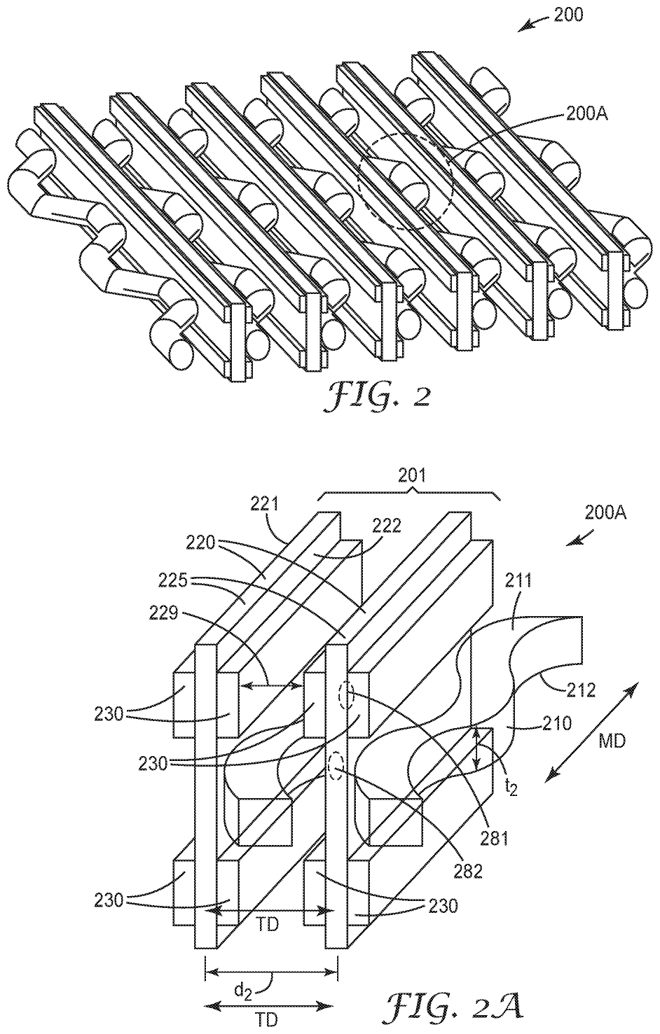

Referring to FIGS. 2 and 2A, exemplary coextruded polymeric netting described herein 200 (and portion thereof 200A) having a machine direction MD and transverse direction TD. Coextruded polymeric netting 200 comprising plurality of pairs 201 of first segments 210 comprising first material, second segments 220 comprising second material, and a third material 230, different from the first and second materials. First segments 210 each have first and second opposed major surfaces 211, 212 and thickness t2. Adjacent first segments 210 are joined together via second segment 220. Second segments 220 extend from second major surface 212 past first major surface 211 of each first adjacent segment 210 and has distal end 225. Second segments 220 have first and second opposed major surfaces 221, 222. There is gap 229 between adjacent second segments 220. Third material 230 is on at least one of first or second major surfaces 221, 222 (as shown on both the first and second major surfaces 221, 222) of at least every other (as shown on each) second segment 220. First segments 210, second segments 220, and third material 230 each extend continuously for at least 5 mm in the machine direction. First and second materials of adjacent pairs 201 are periodically bonded together in machine direction MD. Distance d₂ is the repeating distance between second segments and can be used to calculate the second segments per centimeter. Region 1₂ with demarcation between adhesive and second segments is shown as reference 281. Region 2₂ without demarcation is shown as reference 282.

“Bond regions” as used herein refers to a line of demarcation between two segments bonded together. A demarcation line or boundary region can be detected as described in the Example using Differential Scanning calorimetry (DSC). Comparing by temperature modulated differential scanning calorimetry a region containing mostly a demarcation line (e.g., in FIG. 1A, Region 1 181) versus a region that does not substantially contain material from the demarcation line (in FIG. 1A, Region 2 182) a difference in heat flow/heat capacity is observed that is believed to be consistent with an energy release or reduction in molecular orientation/internal stress. That is, although not wanting to be bound by theory, it is believed that the thermal signatures of the regions may be a combination of material thermal transitions and the material response to retained thermal/processing history. Bonds are formed, for example, when two adjacent molten polymer segments collide with each other. Adjacent segments are extruded at alternating speeds such that adjacent molten segments continually collide, forming bonds, and then part, forming the net openings. Segments are extruded in the same direction, and thus, these bonds are parallel bonds, all formed in the same direction. The bonds between segments are in the same plane, they do not cross over each other. For a given segment there is a first segment on one side which intermittently bonds, and a second segments on the opposite side which is also intermittently bonded. Bond regions are continuations of the two segments, and thus the bond region comprises the sum of the two adjacent segments. Typically, segments continue without disconnect and can be followed continuously through the bond regions.

In some embodiments, there is a demarcation line between the third material and the second material of the second segments.

In some embodiments, the first and second materials are at least one of a thermoplastic resin (e.g., at least one of, including copolymers and blends thereof, a polyolefin (e.g., polypropylene and polyethylene), a polyvinyl chloride, a polystyrene, a nylon, a polyester (e.g., polyethylene terephthalate) or an elastomer (e.g., an ABA block copolymer, a polyurethane, a polyolefin elastomer, a polyurethane elastomer, a metallocene polyolefin elastomer, a polyamide elastomer, an ethylene vinyl acetate elastomer, and a polyester elastomer)). When articles described herein are used in medical applications (e.g., as a wrap around an appendage), it can be desirable for the article to be sufficiently transparent or translucent to view or generally view the skin under the wrap). Materials that may provide such transparent or translucent articles include thermoplastic elastomers that are essentially non-crystalline (e.g., ethylene vinyl acetate copolymers, polyurethane, polyolefin copolymers, and styrenic block copolymers).

In some embodiments, the segments are within the same plane.

In some embodiments, each second segment has a height extending from the first major surface of the adjacent first segment to the distal end of that second segment, wherein the third material extends up to 50 (in some embodiments, up to 60, 70, 75, 80, 85, 90, or even up to 95) percent of the height of that second segment from the first major surface of the first segment toward the distal end.

In some embodiments, the third material is also on the first major surface of the first segment between second segments.

In some embodiments, a portion of the first major surface of the first segment between second segments is free of adhesive.

In some embodiments, each second segment has a height extending from the first major surface of the adjacent first segment to the distal end of that second segment, wherein adjacent pairs of second segments in a repeating pattern have different heights, wherein a second segment having its major surface free of adhesive is shorter (in some embodiments, at least 10, 20, 25, 30, 40, 50, 60, 70, 75, or even at least 80 percent shorter) than the second segment in the pair having the adhesive on the major surfaces of its side.

In some embodiments, the second segments are generally parallel to each other and generally perpendicular to the first major surface of the adjacent first segments.

In some embodiments, the first segments comprise first material, the second segments comprise second material, and the adhesive comprises third material, wherein the first and second are the same material and different from the third material.

In some embodiments, the first segments comprise first material, the second segments comprise second material, and the adhesive comprises third material, wherein the first, second, and third materials are different from each other.

In some embodiments, the second segments have a height from the first major surface of the adjacent segment to the distal ends of the second segments are in a range from 0.05 to 5 (in some embodiments, in a range from 0.1 to 2, or even 0.1 to 1) mm.

In some embodiments, the second segments have a longest cross-sectional dimension in a range from 0.05 to 0.5 (in some embodiments, in a range from 0.05 to 0.2, or even 0.05 to 0.1) mm.

In some embodiments, the second segments have an aspect ratio (i.e., height from the first major surface of the adjacent first segment to width) of at least 1.5:1 (in some embodiments, at least 2:1, 3:1, or even at least 4:1).

In some embodiments, the first segments are spaced apart not more than 5 mm (in some embodiments, not more than 1 mm).

In some embodiments, there is a distance between the first and second major surfaces of the first segments in a range from 0.025 mm to 1 mm (in some embodiments, in a range from 0.025 mm to 0.5 mm, 0.025 mm to 0.2 mm, or even 0.025 mm to 0.1 mm).

In some embodiments, there are at least 2.5 (in some embodiments, at least 5, 10, 15, 20, 25, 30, 35, or even up to 40) second segments per cm.

In some embodiments, the third material has a thickness in a range from 0.001 to 0.25 (in some embodiments in a range from, 0.001 to 0.1, 0.001 to 0.05, 0.001 to 0.025, or even 0.001 to 0.01) mm.

In some embodiments, the third material is adhesive. In some embodiments, the adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive. In some embodiments, the styrene block copolymer rubber is of the form as described in the U.S. Pat. No. 5,296,547 (Nestegard et al.) and U.S. Pat. No. 5,393,787 (Nestegard et al.).

In some embodiments, the adhesive is on at least one of the first and second major surfaces of each second segment.

In some embodiments, a portion of the major surface adjacent to the respective distal end of the second segments are free of the adhesive.

In some embodiments, the distal ends of at least some (in some embodiments, all) of the second segments are free of adhesive.

In another aspect, the present disclosure describes a method of making a coextruded polymeric netting described herein, the method comprising:

providing an extrusion die comprising of at least three cavities, a dispensing surface, and fluid passageways between the at least three cavities and the dispensing surface, wherein the dispensing surface has an array of first dispensing orifices separated by an array of second dispensing orifices, wherein the first and second dispensing orifices each have a height and a width, wherein the height of the second dispensing orifices is at least two times larger than the height of the first dispensing orifices, and wherein the second dispensing orifices comprises a first plurality of a repeating sequence of shims that together provide a fluid passageway between the third cavity and the third orifice, a second plurality of shims that provides a spacer section, and a third plurality of a repeating sequence of shims that together provide a fluid passageway between the second cavity and a second orifice; and

dispensing polymeric ribbons from the second dispensing orifices at a first speed while simultaneously dispensing polymeric segments from the first dispensing orifices at a second speed to provide the polymeric netting, wherein the second speed is at least twice the first speed.

Coextruded polymeric articles described herein (including that shown in FIGS. 1-3), each of the segments and third material portions may be considered monolithic (i.e., having a generally uniform composition) and are not fibrous. This is accomplished by formation of weld lines, called demarcation lines at the die region where polymer at the dispensing orifices merge together at the distal opening. Further, the segments and the adhesive are not nonwoven materials, nor are they coated or added via as a secondary step. In some embodiments described below, however, portions of the articles may be apertured. Typically, the segments and third material are co-extruded and melt bonded together to form coextruded, continuous, polymeric articles. Referring again to FIGS. 1 and 1A, coextruded polymeric article 100 can be prepared, for example, by extrusion from a die having a variety of passageways from cavities within the die to a dispensing surface with orifices, including exemplary dies described herein (see, e.g., FIG. 14). The die may conveniently be comprised of a plurality of shims comprising of at least three cavities, a dispensing surface, and fluid passageways between the at least three cavities and the dispensing surface, wherein the dispensing surface has an array of first dispensing orifices separated by an array of second dispensing orifices, wherein the second dispensing orifices comprises a first plurality of a repeating sequence of shims that together provide a fluid passageway between the third cavity and the third orifice, a second plurality of shims that provides a spacer section, and a third plurality of a repeating sequence of shims that together provide a fluid passageway between the second cavity and a second orifice.

Referring again to FIGS. 2 and 2A, coextruded polymeric article 200 can be prepared, for example, by extrusion from a die having a variety of passageways from cavities within the die to a dispensing surface with orifices, including exemplary dies described herein (see, e.g., FIG. 14). The die may conveniently be comprised of a plurality of shims comprising of at least three cavities, a dispensing surface, and fluid passageways between the at least three cavities and the dispensing surface, wherein the dispensing surface has an array of first dispensing orifices separated by an array of second dispensing orifices, wherein the second dispensing orifices comprises a first plurality of a repeating sequence of shims that together provide a fluid passageway between the third cavity and a pair of third orifices, a second plurality of shims that provides a spacer section, and a third plurality of a repeating sequence of shims that together provide a fluid passageway between the second cavity and a second orifice.

In some embodiments, the shims will be assembled according to a plan that provides a sequence of shims of diverse types. Since different applications may have different requirements, the sequences can have diverse numbers of shims. The sequence may be a repeating sequence that is not limited to a particular number of repeats in a particular zone. Or the sequence may not regularly repeat, but different sequences of shims may be used. The shape of the passageways within, for example, a sequence of shims, may be identical or different. Examples of passageway cross-sectional shapes include round, square, and rectangular shapes. In some embodiments, the shims that provide a passageway between one cavity and the dispensing slot might have a flow restriction compared to the shims that provide a passageway between another cavity and the dispensing slot. The width of the distal opening within, for example, a different sequence of shims, may be identical or different. For example, the portion of the distal opening provided by the shims that provide a passageway between one cavity and the dispensing orifice could be narrower than the portion of the distal opening provided by the shims that provide a passageway between another cavity and the dispensing orifice. In general, the distal opening to create the second segments is much longer than the distal opening to create the first segment.

Individual cavities and passageways provide a conduit for polymer to orifices to create the segments and third material portions. First segments are formed from the first segment plurality of orifices. Second segments are formed from the second segment plurality of orifices. First and second segments weld together after the die exit, to form intermittently bonded netting. Individual flow streams of the second and third material merge together in the second segment orifice to form a continuous, solid second segment. The second dispensing orifices create demarcation lines between the second material and the third material. A gap between the first and second dispensing orifices enables the intermittent bonding between first and second segments immediately at the exit of the die.

In some embodiments, extrusion dies described herein include a pair of end blocks for supporting the plurality of shims. In these embodiments, it may be convenient for one, or even all, of the shims to each have at least one through-holes for the passage of connectors between the pair of end blocks. Bolts disposed within such through-holes are one convenient approach for assembling the shims to the end blocks, although the ordinary artisan may perceive other alternatives for assembling the extrusion die. In some embodiments, the at least one end block has an inlet port for introduction of fluid material into one, or more, of the cavities.

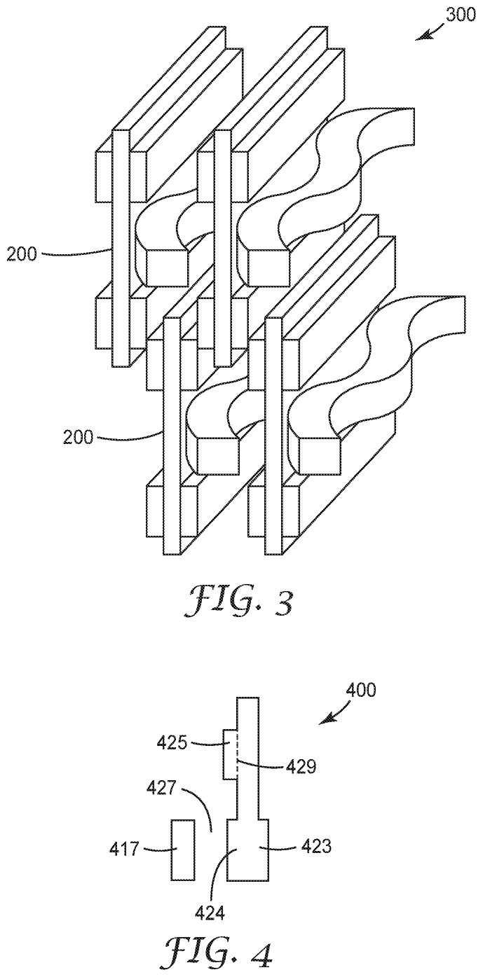

In some embodiments, the shims will be assembled according to a plan that provides a repeating sequence of shims of diverse types. The repeating sequence can have diverse numbers of shims per repeat. For a first example, a repeating sequence comprised of five different shims is described below to create the orifice pattern shown in FIG. 4 to create the coextruded polymeric article shown in FIGS. 1 and 1A. When that five-shim repeating sequence is properly provided with molten polymer, it extrudes a continuous first segment and a continuous second segment of the second and third materials for the second segment. These two segments bond together at the exit of the die to form intermittent bonds between the first and second segment. A bond region also forms between the second and third materials, within the second segment. The bond region will form a demarcation line, as described in region 181 versus 182 in FIG. 1A.

In some embodiments, the assembled shims (conveniently bolted between the end blocks) further comprise a manifold body for supporting the shims. The manifold body has at least one (e.g., in some embodiments, at least two three, four, or more) manifold therein, the manifold having an outlet. An expansion seal (e.g., made of copper or alloys thereof) is disposed to seal the manifold body and the shims, such that the expansion seal defines a portion of at least one of the cavities (in some embodiments, a portion of both the first and second cavities), and such that the expansion seal allows a conduit between the manifold and the cavity.

Typically, the passageway between cavity and dispensing orifice is up to 25 mm in length. Sometimes the fluid passageways leading to one array has greater fluid restriction than the fluid passageways leading to at least one of the other arrays. Typically, the combined length of passageway of the second and third material is up to 5 mm. The combined passageway may need to be shortened, and in some embodiments eliminated, dependent upon the viscosity ratio of the second and third materials.

The shims for dies described herein typically have thicknesses in the range from 50 micrometers to 125 micrometers, although thicknesses outside of this range may also be useful. Typically, the fluid passageways have thicknesses in a range from 50 micrometers to 750 micrometers, and lengths less than 25 mm (with generally a preference for smaller lengths for decreasingly smaller passageway thicknesses), although thicknesses and lengths outside of these ranges may also be useful. For large diameter fluid passageways, several smaller thickness shims may be stacked together, or single shims of the desired passageway width may be used.

The shims are tightly compressed to prevent gaps between the shims and polymer leakage. For example, 12 mm (0.5 inch) diameter bolts are typically used and tightened, at the extrusion temperature, to their recommended torque rating. Also, the shims are aligned to provide uniform extrusion out the extrusion orifice, as misalignment can lead to segments extruding at an angle out of the die which inhibits desired bonding of the net. To aid in alignment, an alignment key can be cut into the shims. Also, a vibrating table can be useful to provide a smooth surface alignment of the extrusion tip.

In practicing methods described herein, the polymeric materials might be solidified simply by cooling. This can be conveniently accomplished passively by ambient air, or actively, for example, by quenching the extruded first and second polymeric materials on a chilled surface (e.g., a chilled roll). In some embodiments, any of the first, second, third or fourth polymeric materials are low molecular weight polymers that need to be cross-linked to be solidified, which can be done, for example, by electromagnetic or particle radiation. In some embodiments, it is desirable to maximize the quenching time to increase the bond strength.

FIG. 3 is a schematic cross-sectional view of two exemplary coextruded polymeric articles (i.e., a first and a second) shown in FIGS. 2 and 2A wherein a portion of some of the second segments, shown as reference 200, of the first coextruded polymeric netting are engaged between some of the adjacent second segments of the second coextruded polymeric netting. FIG. 3 shows precise alignment of second segments within the gaps of the mating second segments. In practice precise alignment is not required. The second segments prevent generally planar surfaces from contacting the adhesive. The narrowness of the second segments enables them to continuously, or in some embodiments, intermittently bond to the adhesive of the first segment. The result of this construction is an adhesive tape which is very breathable, because it is a net, and is also not sticky, because adhesive generally does not contact the generally planar surfaces.

FIG. 4 is a schematic cross-sectional view of an exemplary die orifice pattern just upstream from the dispensing slot of the die employed in the formation of an exemplary coextruded polymeric article described herein. Orifice plan 400 shows orifices for a third material on only one of the major surfaces of the second segment. Orifice plan 400 shows first orifices 417, and second orifices 423. Orifice 423 combines passageways from second and third passageway which emerge in the orifice as shown in reference 424, and 425 to create a single flow stream. Line 429 shows the location of the spacer between second and third passageways 424, 425, and is also the line of demarcation between the second and third material. The demarcation lines are also created at orifices separated by spacer shims. Spacing 427 enables intermittent bonding in the machine direction between the first and second segment. The intermittent bonding creates the netting construction.

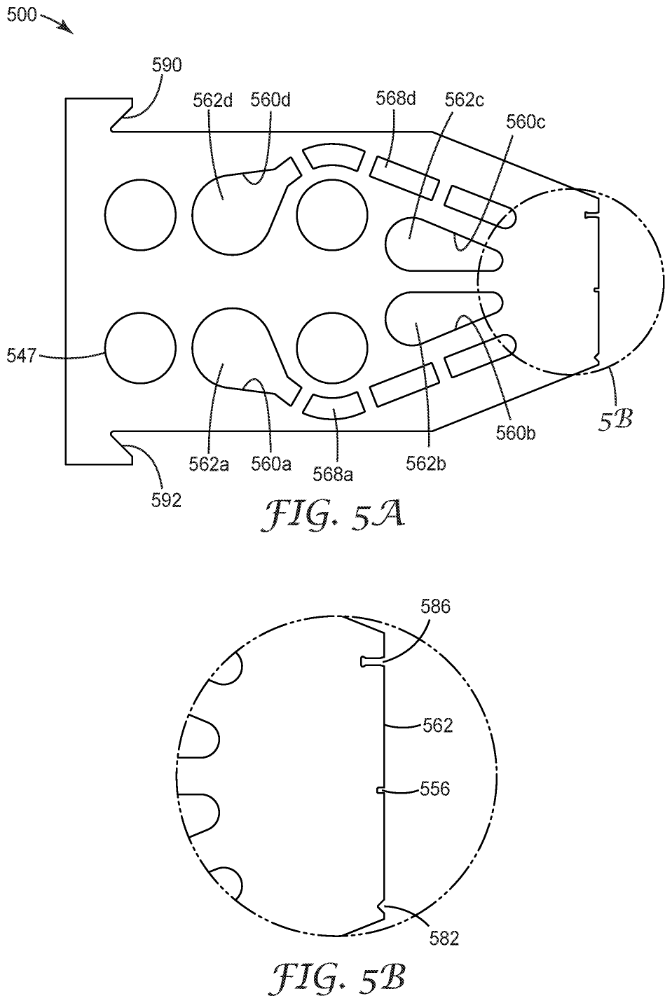

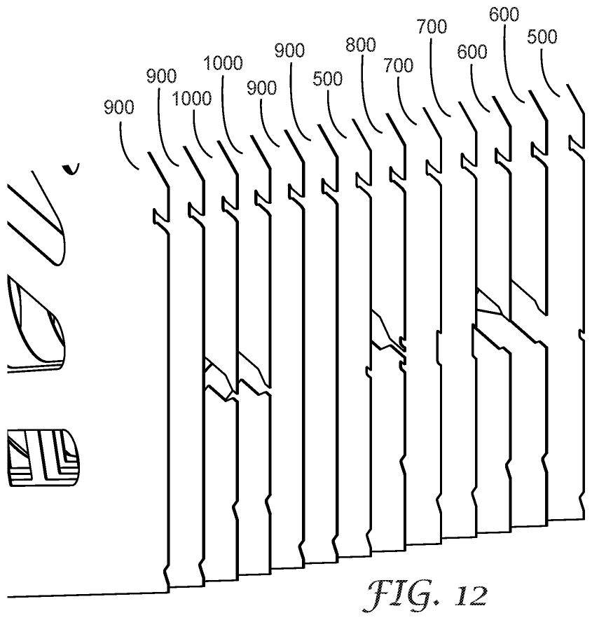

Referring now to FIGS. 5A and 5B, a plan view of shim 500 is illustrated. Shim 500 has first aperture 560a, second aperture 560b third aperture 560c, and fourth aperture 560d. When shim 500 is assembled with others as shown in FIGS. 11 and 12, aperture 560a aids in defining first cavity 562a, aperture 560b aids in defining second cavity 562b, aperture 560c aids in defining third cavity 562c, and aperture 560d aids in defining third cavity 562d. Passageways 568a, and 568d cooperate with analogous passageways on adjacent shims to allow passage from cavities 562a, and 562d to the dispensing surfaces of the appropriate shims when the shims are assembled as shown in FIGS. 11 and 12.

Shim 500 has several holes 547 to allow the passage of, for example, bolts, to hold shim 500 and others to be described below into an assembly. Shim 500 also has dispensing surface 562, and in this embodiment, dispensing surface 562 has indexing groove 586 which can receive an appropriately shaped key to ease assembling diverse shims into a die. This embodiment has shoulders 590 and 592 which can assist in mounting the assembled die with a mount of the type shown in FIG. 14. Shim 500 has dispensing opening 556. Dispensing opening 556 has no connection to the cavities. This is because shim 500 is a spacer shim. Opening 556 completes the orifice pattern of the second orifice as will be further described.

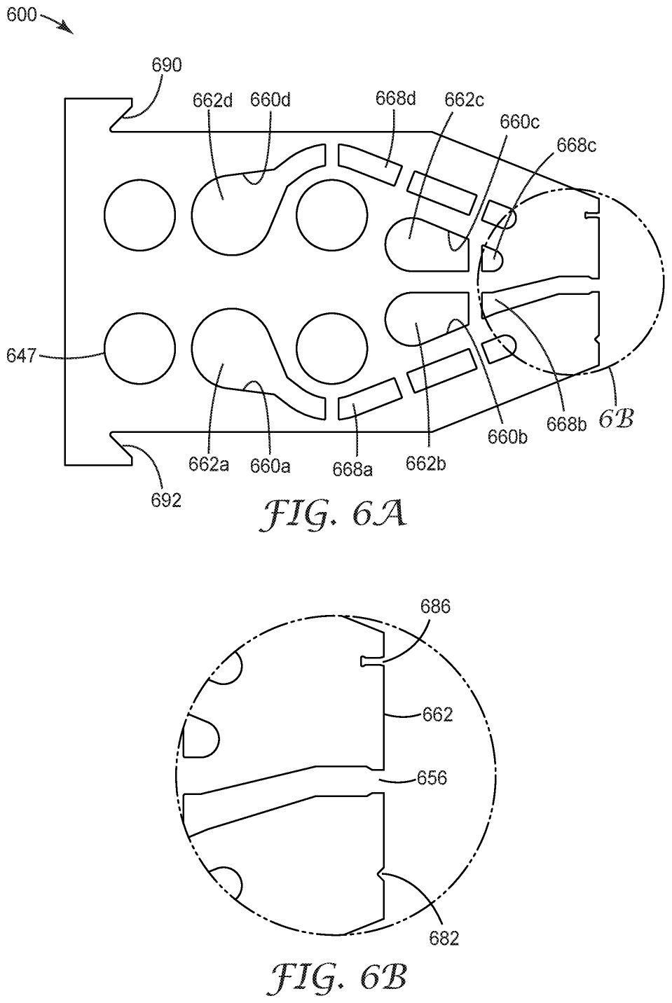

Referring now to FIGS. 6A and 6B, a plan view of shim 600 is illustrated. Shim 600 has first aperture 660a, second aperture 660b, third aperture 660c, and fourth aperture 660d. When shim 600 is assembled with others as shown in FIGS. 11 and 12, aperture 660a aids in defining first cavity 662a, aperture 660b aids in defining second cavity 662b, aperture 660c aids in defining third cavity 662c, and aperture 660d aids in defining third cavity 662d. Passageways 668a, 668b, 668c, and 668d cooperate with analogous passageways on adjacent shims to allow passage from cavities 662a, 662b, 662c, and 662d to the dispensing surfaces of the appropriate shims when the shims are assembled as shown in FIGS. 11 and 12.

Shim 600 has several holes 647 to allow the passage of, for example, bolts, to hold shim 600 and others to be described below into an assembly. Shim 600 also has dispensing surface 662, and in this embodiment, dispensing surface 662 has indexing groove 686 which can receive an appropriately shaped key to ease assembling diverse shims into a die. The shim may also have identification notch 682 to help verify that the die has been assembled in the desired manner. This embodiment has shoulders 690 and 692 which can assist in mounting the assembled die with a mount of the type shown in FIG. 14. Shim 600 has dispensing opening 656. Dispensing opening 656 has connection to cavity 662b. Shim 600 creates a portion of the second segment and the second orifice.

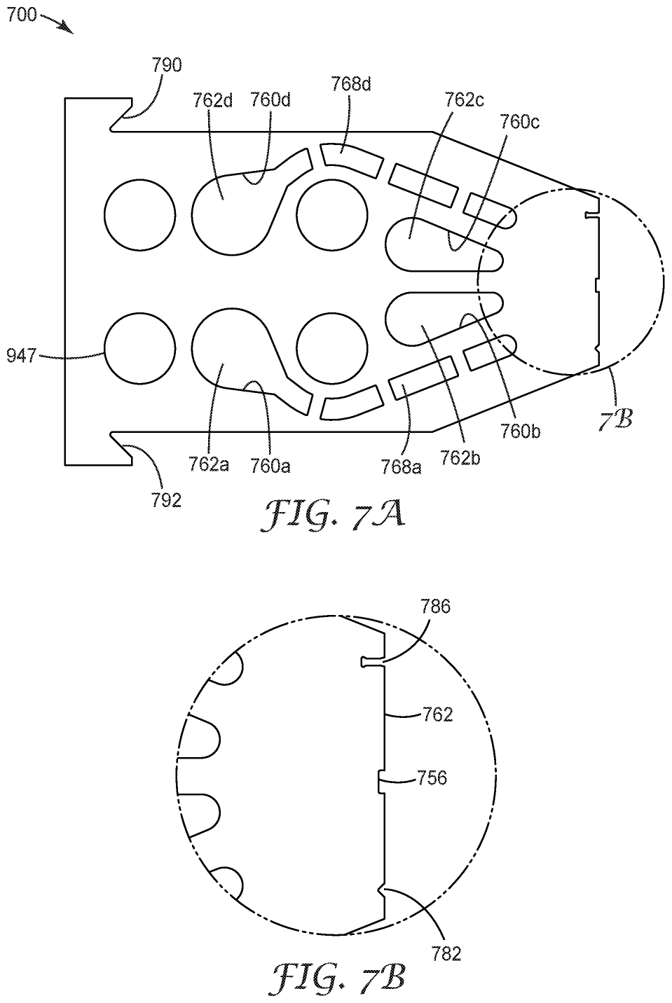

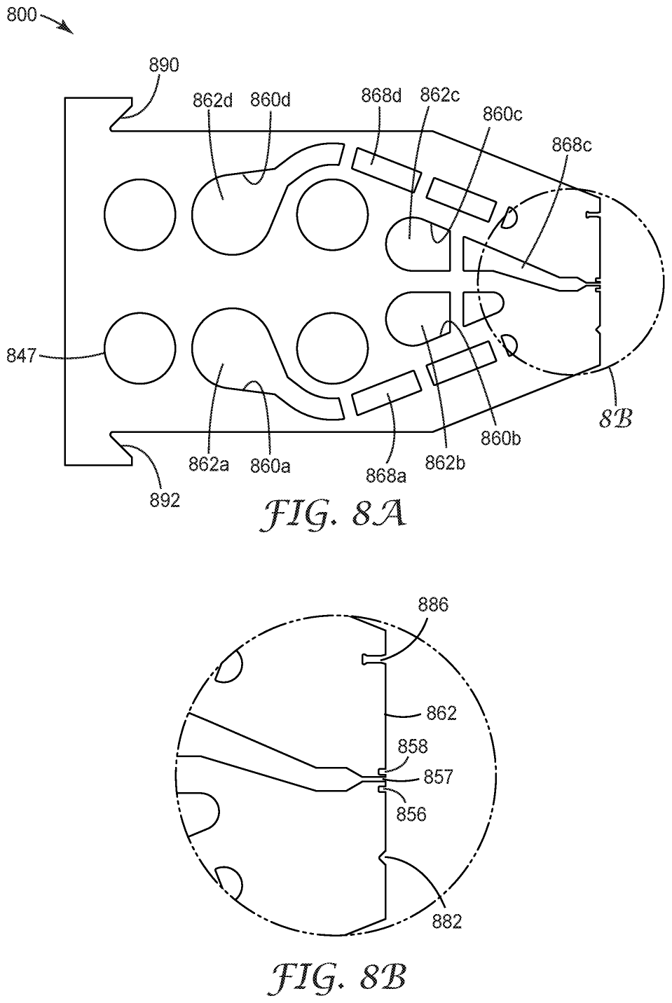

Referring now to FIGS. 7A and 7B, a plan view of shim 700 is illustrated. Shim 700 has first aperture 760a, second aperture 760b third aperture 760c, and fourth aperture 760d. When shim 700 is assembled with others as shown in FIGS. 11 and 12, aperture 760a aids in defining first cavity 762a, aperture 760b aids in defining second cavity 762b, aperture 760c aids in defining third cavity 762c, and aperture 760d aids in defining third cavity 762d. Passageways 768a, and 768d cooperate with analogous passageways on adjacent shims to allow passage from cavities 762a and 762d to the dispensing surfaces of the appropriate shims when the shims are assembled as shown in FIGS. 11 and 12.

Shim 700 has several holes 747 to allow the passage of, for example, bolts, to hold shim 700 and others to be described below into an assembly. Shim 700 also has dispensing surface 762, and in this embodiment, dispensing surface 762 has indexing groove 786 which can receive an appropriately shaped key to ease assembling diverse shims into a die. The shim may also have identification notch 782 to help verify that the die has been assembled in the desired manner. This embodiment has shoulders 790 and 792 which can assist in mounting the assembled die with a mount of the type shown in FIG. 14. Shim 700 has dispensing opening 756. Dispensing opening 756 has no connection to the cavities. This is because shim 700 is a spacer shim, providing passageway formation between the second and third passageway. Opening 756 provides completes the orifice pattern of the second orifice as will be further described.

Referring to FIGS. 8A and 8B, a plan view of shim 800 is illustrated. Shim 800 has first aperture 860a, second aperture 860b, third aperture 860c, and fourth aperture 860d. When shim 800 is assembled with others as shown in FIGS. 11 and 12, aperture 860a aids in defining first cavity 862a, aperture 860b aids in defining second cavity 862b, aperture 860c aids in defining third cavity 862c, and aperture 860d aids in defining third cavity 862d. Passageways 868a, 868c, and 868d cooperate with analogous passageways on adjacent shims to allow passage from cavities 862a, 862c, and 862d to the dispensing surfaces of the appropriate shims when the shims are assembled as shown in FIGS. 11 and 12.

Shim 800 has several holes 847 to allow the passage of, for example, bolts, to hold shim 800 and others to be described below into an assembly. Shim 800 also has dispensing surface 862, and in this embodiment, dispensing surface 862 has indexing groove 886 which can receive an appropriately shaped key to ease assembling diverse shims into a die. The shim may also have identification notch 882 to help verify that the die has been assembled in the desired manner. This embodiment has shoulders 890 and 892 which can assist in mounting the assembled die with a mount of the type shown in FIG. 14. Shim 800 has dispensing opening 856, 857, and 858 in dispensing surface 862 and may be more clearly seen in the expanded view shown in FIG. 8B. Dispensing opening 857 has connection to cavity 862c. It might seem that there is no path from cavity 862c to dispensing opening 857, via, for example, passageway 868c, but the flow has a route in the perpendicular-to-the-plane-of-the-drawing dimension when the sequence of shims is completely assembled. Dispensing openings 856 and 858 do not have a connection to any of the cavities. Although not wanting to be bound by theory, it is believed that these openings aid in balancing the flow from the second orifice. Shim 800 creates a portion of the second segment.

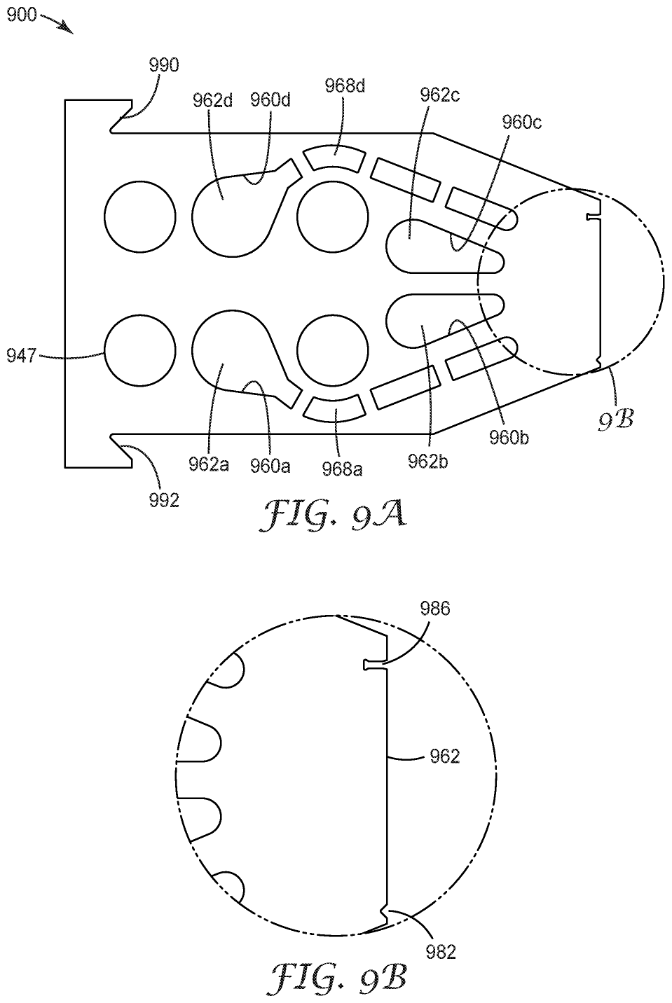

Referring to FIGS. 9A and 9B, a plan view of shim 900 is illustrated. Shim 900 has first aperture 960a, second aperture 960b, third aperture 960c, and fourth aperture 960d. When shim 900 is assembled with others as shown in FIGS. 11 and 12, aperture 960a aids in defining first cavity 962a, aperture 960b aids in defining second cavity 962b, aperture 960c aids in defining third cavity 962c, and aperture 960d aids in defining third cavity 962d. Passageways 968a and 968d cooperate with analogous passageways on adjacent shims to allow passage from cavities 962a and 962d to the dispensing surfaces of the appropriate shims when the shims are assembled as shown in FIGS. 11 and 12.

Shim 900 has several holes 947 to allow the passage of, for example, bolts, to hold shim 900 and others to be described below into an assembly. Shim 900 also has dispensing surface 962, and in this embodiment, dispensing surface 962 has indexing groove 986 which can receive an appropriately shaped key to ease assembling diverse shims into a die. The shim may also have identification notch 982 to help verify that the die has been assembled in the desired manner. This embodiment has shoulders 990 and 992 which can assist in mounting the assembled die with a mount of the type shown in FIG. 14. Shim 900 does not have a dispensing opening. It also forms the spacing between the first and second segments.

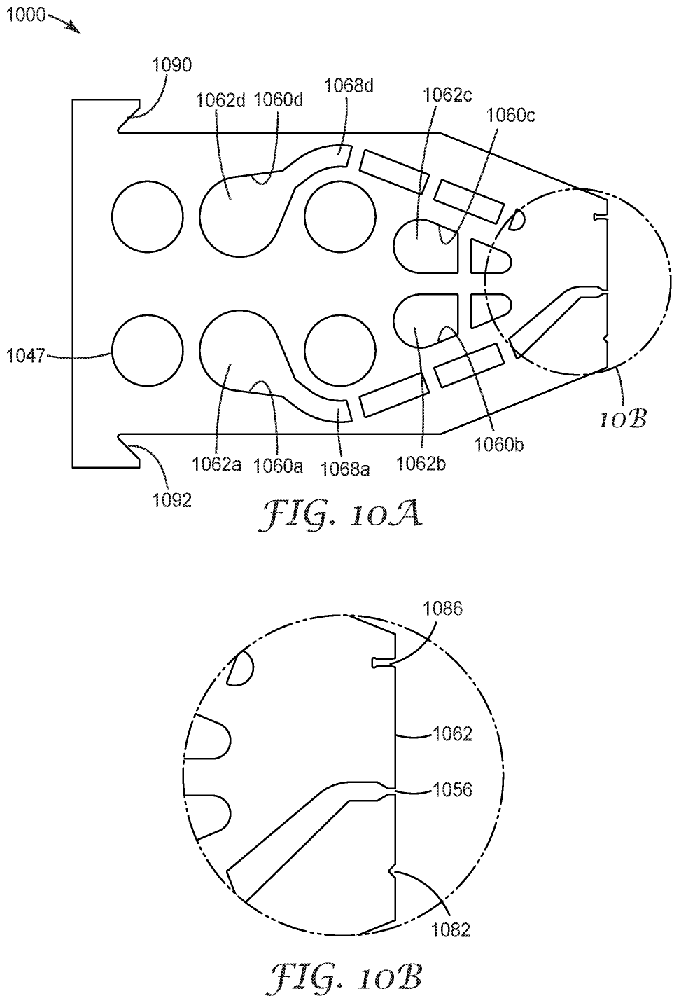

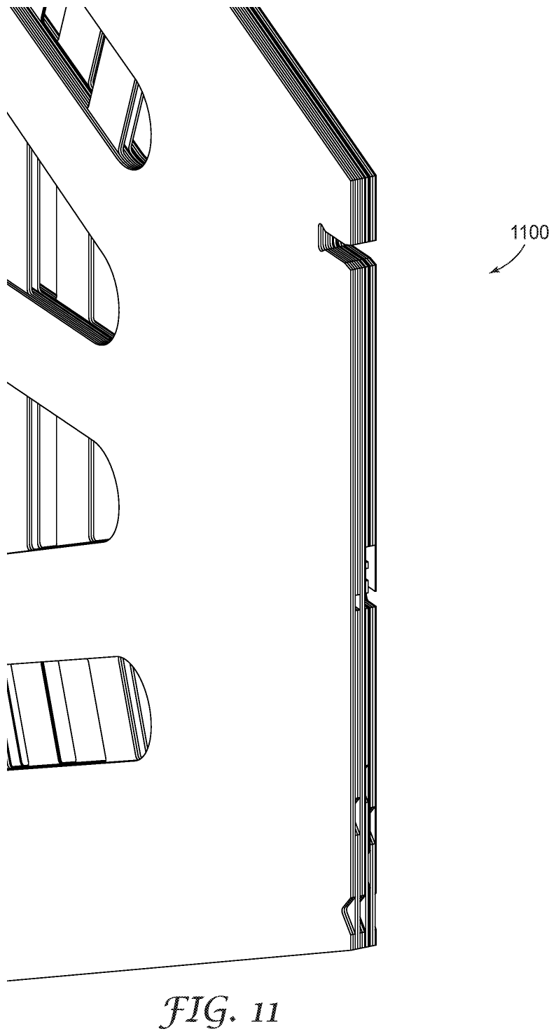

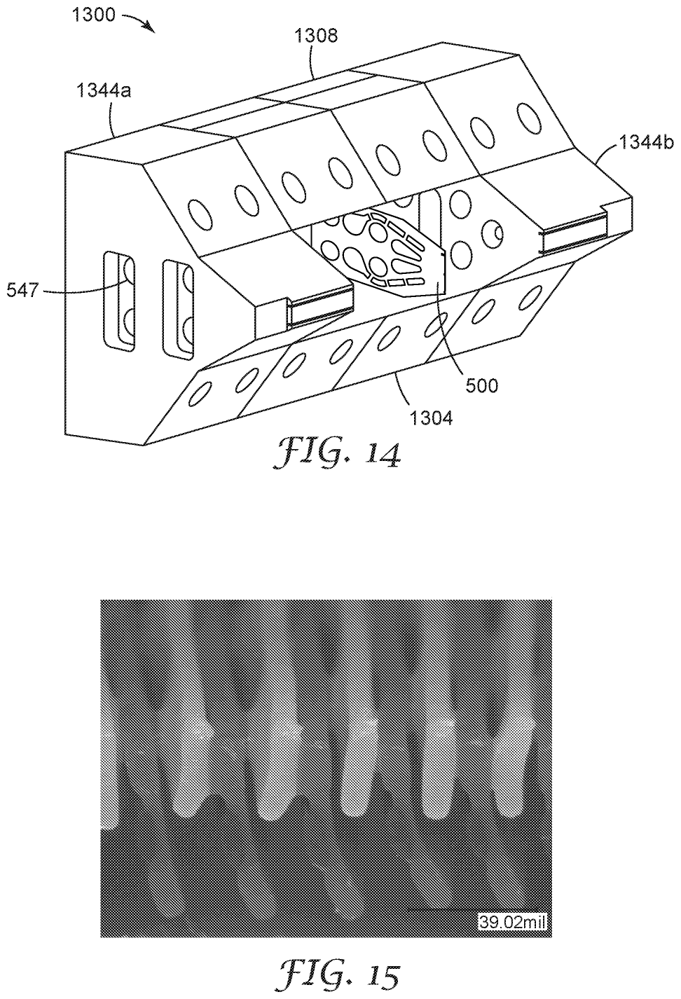

Referring to FIGS. 10A and 10B, a plan view of shim 1000 is illustrated. Shim 1000 has first aperture 1060a, second aperture 1060b, third aperture 1060c, and fourth aperture 1060d. When shim 1000 is assembled with others as shown in FIGS. 14 and 15, aperture 1060a aids in defining first cavity 1062a, aperture 1060b aids in defining second cavity 1062b, aperture 1060c aids in defining third cavity 1062c, and aperture 1060d aids in defining third cavity 1062d. Passageways 1068a and 1068d cooperate with analogous passageways on adjacent shims to allow passage from cavities 1062a and 1062d to the dispensing surfaces of the appropriate shims when the shims are assembled as shown in FIGS. 11 and 12.

Shim 1000 has several holes 1047 to allow the passage of, for example, bolts, to hold shim 1000 and others to be described below into an assembly. Shim 1000 also has dispensing surface 1062, and in this embodiment, dispensing surface 1062 has indexing groove 1086 which can receive an appropriately shaped key to ease assembling diverse shims into a die. The shim may also have identification notch 1082 to help verify that the die has been assembled in the desired manner. This embodiment has shoulders 1090 and 1092 which can assist in mounting the assembled die with a mount of the type shown in FIG. 14. Shim 1000 has dispensing opening 1056, in dispensing surface 1062. Shim 1000 creates the orifice for the first segment.

Referring to FIG. 11, a perspective assembly drawing of a several different repeating sequences of shims, collectively 1100, employing the shims of FIGS. 5-10 to produce coextruded polymeric article 100 shown in FIGS. 1 and 1A are shown. It can be seen that collectively the shims form a dispensing surface shown in further detail in FIG. 4.

Referring to FIG. 12, an exploded perspective assembly drawing of a repeating sequence of shims employing the shims of FIGS. 5-10 is illustrated. In the illustrated embodiment, the repeating sequence includes, from bottom to top as the drawing is oriented, one instance of shim 500, two instances of shim 600, two instances of shim 700, one instance of shim 800, one instance of shim 500, two instances of shim 900, two instances of shim 1000, and two instances of shim 900.

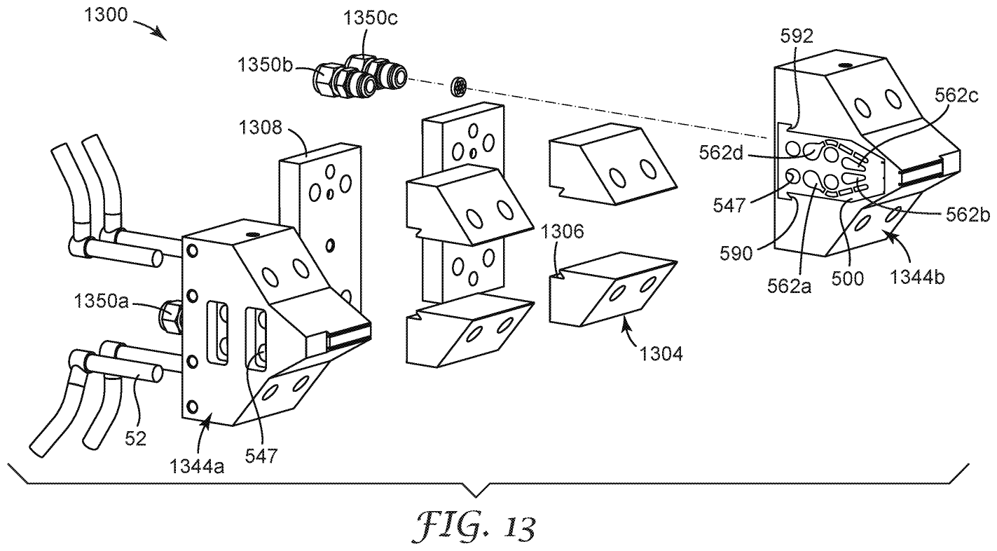

Referring to FIG. 13, an exploded perspective view of a mount 1300 suitable for an extrusion die composed of multiple repeats of the repeating sequence of shims of FIGS. 11 and 12 is illustrated. Mount 1300 is particularly adapted to use shims 500, 600, 700, 800, 900, and 1000 as shown in FIGS. 5-10. For visual clarity, however, only a single instance of shims is shown in FIG. 13. The multiple repeats of the repeating sequence of shims are compressed between two end blocks 1344a and 1344b. Conveniently, through bolts can be used to assemble the shims to end blocks 1344a and 1344b, passing through holes 547 in shims 500 et al.

In this embodiment, inlet fittings 1350a, 1350b, 1350c, and a fourth fitting not shown provide a flow path for four streams of molten polymer through end blocks 1344a and 1344b to cavities 562a, 562b, and 562c, and 562d. Compression blocks 1304 have notch 1306 that conveniently engages the shoulders on shims (e.g., 590 and 592) on 500. When mount 1300 is completely assembled, compression blocks 1304 are attached by, for example, machine bolts to backplates 1308. Holes are conveniently provided in the assembly for the insertion of cartridge heaters 52.

Referring to FIG. 14, a perspective view of the mount 1300 of FIG. 13 is illustrated in a partially assembled state. A few shims, for example, 500 are in their assembled positions to show how they fit within mount 1300, but most of the shims that would make up an assembled die have been omitted for visual clarity.

Typically, the polymeric segments are extruded in the direction of gravity. This enables collinear segments to collide with each other before becoming out of alignment with each other. In some embodiments, it is desirable to extrude the segments horizontally, especially when the extrusion orifices of the first and second polymer are not collinear with each other.

In practicing methods described herein, the polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation. In some embodiments, it is desirable to maximize the time to quenching to increase the bond strength.

Optionally, it may be desirable to stretch the as-made netting. Stretching may orientate the segments and has been observed to increase the tensile strength properties of the netting. Stretching may also reduce the overall segment size, which may be desirable for applications which benefit from a relatively low basis weight. As an additional example, if the materials and the degree of stretch, are chosen correctly, the stretch can cause some of the segments to yield while others do not, tending to form loft (e.g., the loft may be created because of the length difference between adjacent bonded netting segments or by curling of the bonds due to the yield properties of the segments forming the bond). The attribute can be useful for packaging applications where the material can be shipped to package assembly in a relatively dense form, and then lofted, on location.

Portions of the exteriors of the first and second segments bond together at the bond regions. In methods described herein for making nettings described herein, the bonding occurs in a relatively short period of time (typically less than 1 second). The bonds are formed from continuous molten segments as they exit the die. The bonds are formed, parallel to each other and parallel to the machine direction of the netting. The bond regions, as well as the segments typically cool through air and natural convection and/or radiation. In selecting polymers for the segments, in some embodiments, it may be desirable to select polymers of bonding segments that have dipole interactions (or H-bonds) or covalent bonds. Bonding between segments has been observed to be improved by increasing the time that the segments are molten to enable more interaction between polymers. Bonding of polymers has generally been observed to be improved by reducing the molecular weight of at least one polymer and or introducing an additional co-monomer to improve polymer interaction and/or reduce the rate or amount of crystallization. In some embodiments, the bond strength is greater than the strength of the segments forming the bond. In some embodiments, it may be desirable for the bonds to break and thus the bonds will be weaker than the segments.

In some embodiments, polymeric materials used to make coextruded polymeric articles described herein may comprise a colorant (e.g., pigment and/or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for one or more of the polymeric materials. The amount of colorant(s) to be used in specific embodiments can be readily determined by those skilled in the (e.g., to achieve desired color, tone, opacity, transmissivity, etc.). If desired, the polymeric materials may be formulated to have the same or different colors.

Netting described herein are useful, for example, in fastener systems (e.g., a fastener system comprising at least one netting described herein).

Another exemplary use for coextruded polymeric articles described herein is to make an article comprising first and second coextruded polymeric nettings described herein, wherein a portion of some of the first segments of the first coextruded polymeric netting are engaged between some of the adjacent first segments of the second coextruded polymeric netting. In some embodiments, the engaged first and second coextruded polymeric nettings are the same netting. Referring to FIG. 3, exemplary article 300 comprises first and second coextruded polymeric nettings 200 shown in FIGS. 2 and 2A, wherein a portion of some of the second segments of the first coextruded polymeric netting are engaged between some of the adjacent second segments of the second coextruded polymeric netting.

Netting described herein are useful, for example, for tape landing zones (e.g., in medical applications where the netting is wrapped around an appendage and attached to itself to provide a medical tape landing zone without adhesion to skin), bundling applications where it is desired to maintain breathability without an air tight barrier such as what happens with elastomeric thin film wraps (i.e., the netting construction of the articles described herein facilitates the breathability of the article), and bundling applications where it is desired to have compression wrap without adhesion to the wrapped substrate.

### Exemplary Embodiments

1A. A coextruded polymeric netting having a machine direction comprising:

a plurality of pairs (in some embodiments, at least 3, 4, 5, 10, 25, 50, 100, 250, 500, 750, or even at least 1000 pairs) of:
first segments each having first and second opposed major surfaces and a thickness, the first segments comprising first material;
second segments comprising second material, wherein adjacent first segments are joined together via a second segment, wherein the second segments extend from the second major surface past the first major surface of each first adjacent segment and has a distal end, the second segments having first and second opposed major surfaces, wherein there is a gap between adjacent second segments; and
a third material, different from the first and second materials on at least one of the first or second major surfaces (in some embodiments, on both the first and second major surfaces) of at least every other (in some embodiments, on each) second segment,
   wherein the first segments, second segments, and third material each extend continuously for at least 5 mm in the machine direction (in some embodiments, at least 10 mm, 25 mm, 50 mm, 1 cm, 5 cm, 10 cm, 50 cm, 75 cm, 1 m, 5 m, 10 m, 25 m, 50 m, 100 m, 500 m, or even at least 1000 m), and wherein first and second materials of adjacent pairs are periodically bonded together in the machine direction.
   2A. The coextruded polymeric netting of Exemplary Embodiment 1A, wherein the first segment has first and second opposed major surfaces, wherein the second segment extends past both the first and second surfaces of the first segment, and wherein the third material is on at least one of the first or second major surfaces (in some embodiments, on both the first and second major surfaces) of the second segment both above and below the first segment.
   3A. The coextruded polymeric netting of any preceding A Exemplary Embodiment, wherein the segments are within the same plane.
   4A. The coextruded polymeric netting of any preceding A Exemplary Embodiment, wherein the third material is adhesive.
   5A. The coextruded polymeric netting of Exemplary Embodiment 4A, wherein the adhesive is at least one of an acrylate copolymer pressure sensitive adhesive, a rubber-based adhesive (e.g., those based on at least one of natural rubber, polyisobutylene, polybutadiene, butyl rubber, or styrene block copolymer rubber), a silicone polyurea-based adhesive, a silicone polyoxamide-based adhesive, a polyurethane-based adhesive, or a poly(vinyl ethyl ether)-based adhesive.
   6A. The coextruded polymeric netting of any of Exemplary Embodiments 4A or 5A, wherein a portion of the major surface adjacent to the respective distal end is free of the adhesive.
   7A. The coextruded polymeric netting of any of Exemplary Embodiments 4A to 6A, wherein the adhesive is on at least one of the first and second major surfaces of each second segment.
   8A. The coextruded polymeric netting of any preceding A Exemplary Embodiment, wherein at least some (in some embodiments, all) of the distal ends are free of adhesive.
   9A. The coextruded polymeric netting of any preceding A Exemplary Embodiment, wherein each second segment has a height extending from the first major surface of the adjacent first segment to the distal end of that second segment, wherein the third material extends up to 50 (in some embodiments, up to 60, 70, 75, 80, 85, 90, or even up to 95) percent of the height of that second segment from the first major surface of the first segment toward the distal end.
   10A. The coextruded polymeric netting of any preceding A Exemplary Embodiment, wherein the third material is also on the first major surface of the first segment between second segments.
   11A. The coextruded polymeric netting of any of Exemplary Embodiments 1A to 9A, wherein a portion of the first major surface of the first segment between second segments is free of adhesive.
   12A. The coextruded polymeric netting of any preceding A Exemplary Embodiment, wherein each second segment has a height extending from the first major surface of the adjacent first segment to the distal end of that second segment, wherein adjacent pairs of second segments in a repeating pattern have different heights, wherein a second segment having its major surface free of adhesive is shorter (in some embodiments, at least 10, 20, 25, 30, 40, 50, 60, 70, 75, or even at least 80 percent shorter) than the second segment in the pair having the adhesive on the major surfaces of its side.
   13A. The coextruded polymeric netting of any preceding A Exemplary Embodiment, wherein there is a demarcation line between the first and second segments that is parallel to the segments.
   14A. The coextruded polymeric netting of any preceding A Exemplary Embodiment, wherein there is a demarcation line between the adhesive and the second segments.
   15A. The coextruded polymeric netting of any preceding A Exemplary Embodiment, wherein the second segments are generally parallel to each other and generally perpendicular to the first major surface of the adjacent first segments.
   16A. The polymeric coextruded netting of any preceding A Exemplary Embodiment, wherein the first segments comprise first material, the second segments comprise second material, and the adhesive comprises third material, wherein the first and second are the same material and different from the third material.
   17A. The polymeric coextruded netting of Exemplary Embodiments 1A to 15A, wherein the first segments comprise first material, the second segments comprise second material, and the adhesive comprises third material, wherein the first, second, and third materials are different from each other.
   18A. The coextruded polymeric netting of either Exemplary Embodiment 13A or 16A, wherein the first and second materials are at least one of a thermoplastic resin (e.g., at least one of, including copolymers and blends thereof, a polyolefin (e.g., polypropylene and polyethylene), a polyvinyl chloride, a polystyrene, a nylon, a polyester (e.g., polyethylene terephthalate) or an elastomer (e.g., an ABA block copolymer, a polyurethane, a polyolefin elastomer, a polyurethane elastomer, a metallocene polyolefin elastomer, a polyamide elastomer, an ethylene vinyl acetate elastomer, and a polyester elastomer)).
   19A. The coextruded polymeric netting of any preceding A Exemplary Embodiment, wherein the second segments have a height from the first major surface of the of the adjacent segment to the distal end is in a range from 0.05 to 5 (in some embodiments, in a range from 0.1 to 2, or even 0.1 to 1) mm.
   20A. The coextruded polymeric netting of any preceding A Exemplary Embodiment, wherein the second segments have a longest cross-sectional dimension in a range from 0.05 to 0.5 (in some embodiments, in a range from 0.05 to 0.2, or even 0.05 to 0.1) mm.
   21A. The coextruded polymeric netting of any preceding A Exemplary Embodiment, wherein the second segments have an aspect ratio (i.e., height from the first major surface of the adjacent first segment to width) of at least 1.5:1 (in some embodiments, at least 2:1, 3:1, or even at least 4:1).
   22A. The coextruded polymeric netting of any preceding A Exemplary Embodiment, wherein the first segments are spaced apart not more than 5 mm (in some embodiments, not more than 1 mm).
   23A. The coextruded polymeric netting of any preceding A Exemplary Embodiment having a distance between the first and second major surfaces of the first segments in a range from 0.025 mm to 1 mm (in some embodiments, in a range from 0.025 mm to 0.5 mm, 0.025 mm to 0.2 mm, or even 0.025 mm to 0.1 mm).
   24A. The coextruded polymeric netting of any preceding A Exemplary Embodiment, wherein there are at least 2.5 (in some embodiments, at least 5, 10, 15, 20, 25, 30, 35, or even up to 40) second segments per cm.
   25A. The coextruded polymeric netting of any preceding A Exemplary Embodiment, wherein the third material has a thickness in a range from 0.001 to 0.25 (in some embodiments, in a range from 0.001 to 0.1, 0.001 to 0.05, 0.001 to 0.025, or even 0.001 to 0.01) mm.
   1B. A method of making a coextruded polymeric netting of any preceding A Exemplary Embodiment, the method comprising:

providing an extrusion die comprising of at least three cavities, a dispensing surface, and fluid passageways between the at least three cavities and the dispensing surface, wherein the dispensing surface has an array of first dispensing orifices separated by an array of second dispensing orifices, wherein the first and second dispensing orifices each have a height and a width, wherein the second dispensing orifices each have a height to width aspect ratio of at least two to one, and wherein the height of the second dispensing orifices is at least two times larger than the height of the first dispensing orifices, and wherein the second dispensing orifices comprises a first plurality of a repeating sequence of shims that together provide a fluid passageway between the third cavity and the third orifice, a second plurality of shims that provides a spacer section, and a third plurality of a repeating sequence of shims that together provide a fluid passageway between the second cavity and a second orifice and;

dispensing polymeric ribbons from the second dispensing orifices at a first speed while simultaneously dispensing polymeric segments from the first dispensing orifices at a second speed to provide the polymeric netting, wherein the second speed is at least twice the first speed.

1C. A fastener system comprising any preceding A Exemplary Embodiment coextruded polymeric netting.
1D. A fastener system comprising two of any preceding A Exemplary Embodiment coextruded polymeric nettings.
1E. An article comprising first and second coextruded polymeric nettings of any preceding A Exemplary Embodiment, wherein a portion of some of the second segments of the first coextruded polymeric netting are engaged between some of the adjacent second segments of the second coextruded polymeric netting.
2E. The article of Exemplary Embodiment 1E, wherein the engaged first coextruded and second polymeric nettings are the same netting.

Advantages and embodiments of this invention are further illustrated by the following example, but the particular materials and amounts thereof recited in this example, as well as other conditions and details, should not be construed to unduly limit this invention. All parts and percentages are by weight unless otherwise indicated.

### Example

A co-extrusion die as generally depicted in FIG. 14 and assembled with a multi shim repeating pattern of extrusion orifices as generally illustrated in FIGS. 11 and 12, was prepared. The thickness of the shims in the repeat sequence was 4 mils (0.102 mm) for shims 600, 700, 800, 900, and 1000 and 2 mils (0.51 mm) for shim 500. The shim pattern is shown in FIGS. 5, 6, 7, 8, 9, and 10. These shims were formed from stainless steel, with perforations cut by a wire electron discharge machining. The shims were stacked in a repeating sequence 500, 600, 600, 700, 700, 800, 500, 900, 900, 1000, 1000, 900, and 900. The extrusion orifices were aligned in a collinear, alternating arrangement. The total width of the shim setup was about 7.5 cm (3 inches).

The inlet fittings on the two end blocks were each connected to three conventional single-screw extruders. The extruders feeding two cavities were loaded with polyethylene copolymer (obtained under the trade designation “ELVALOY 12024” from DuPont Company, Wilmington, Del.). The polyethylene for the first cavity, the second segment, was dry blended with 3 wt. % red color concentrate (obtained under the trade designation “PP33643730” from Clariant Corporation, Minneapolis, Minn.). The polyethylene for the second cavity, the third material, was dry blended with 3 wt. % blue color concentrate (obtained under the trade designation “PP554643692” from Clariant Corporation). The polyethylene for the third cavity, the first segment, was dry blended with 3 wt. % white color concentrate (obtained under the trade designation “PP1015100S” from Clariant Corporation). The fourth cavity was not used.

The melt was extruded vertically into an extrusion quench takeaway. The quench roll was a smooth temperature-controlled chrome plated 20 cm diameter steel roll. The quench temperature was controlled with internal water flow. The web path wrapped 180 degrees around the chrome steel roll and then to a windup roll. Under these conditions a polymeric layer was produced as generally depicted in FIG. 1 with third material on one side only of the second segment.

Other process conditions are listed below:

| | | |
|---|---|---|
| Flow rate of first polymer (second segment) | 0.9 | kg/hr. |
| Flow rate of second polymer (third material) | 0.2 | kg/hr. |
| Flow rate of third polymer (first segment) | 0.6 | kg/hr. |
| Extrusion temperature | 190° | C. |
| Quench roll temperature | 10° | C. |
| Quench takeaway speed | 0.5 | m/min |

An optical microscope was used to measure the web profile. A digital optical image of the Example is shown in FIG. 15.

| | | |
|---|---|---|
| Overall netting caliber | 2.32 | micrometers |
| Second segment height | 1675 | micrometers |
| Second segment width | 225 | micrometers |
| First segment height | 914 | micrometers |
| First segment width | 225 | micrometers |
| Bond length | 381 | micrometers |
| Machine direction repeat | 1270 | micrometers |
| Cross direction repeat | 660 | micrometers |

Foreseeable modifications and alterations of this disclosure will be apparent to those skilled in the art without departing from the scope and spirit of this invention. This invention should not be restricted to the embodiments that are set forth in this application for illustrative purposes.

1. A coextruded polymeric netting having a machine direction comprising:
a plurality of pairs of:
first segments each having first and second opposed major surfaces and a thickness, the first segments comprising first material;
second segments comprising second material, wherein adjacent first segments are joined together via a second segment, wherein the second segments extend from the second major surface past the first major surface of each first adjacent segment and has a distal end, the second segments having first and second opposed major surfaces, wherein there is a gap between adjacent second segments; and
a third material, different from the first and second materials on at least one of the first or second major surfaces of at least every other second segment,
wherein the first segments, second segments, and third material each extend continuously for at least 5 mm in the machine direction, and wherein first and second materials of adjacent pairs are periodically bonded together in the machine direction.

2. The coextruded polymeric netting of claim 1, wherein the first segment has first and second opposed major surfaces, wherein the second segment extends past both the first and second surfaces of the first segment, and wherein the third material is on at least one of the first or second major surfaces of the second segment both above and below the first segment.

3. The coextruded polymeric netting of claim 1, wherein the third material is adhesive.

4. The coextruded polymeric netting of claim 3, wherein a portion of the major surface adjacent to the respective distal end is free of the adhesive.

5. The coextruded polymeric netting of claim 3, wherein the adhesive is on at least one of the first and second major surfaces of each second segment.

6. The coextruded polymeric netting of claim 1, wherein the distal ends are free of adhesive.

7. The coextruded polymeric netting of claim 1, wherein each second segment has a height extending from the first major surface of the adjacent first segment to the distal end of that second segment, wherein the third material extends up to 50 percent of the height of that second segment from the first major surface of the first segment toward the distal end.

8. The coextruded polymeric netting of claim 1, wherein a portion of the first major surface of the first segment between second segments is free of adhesive.

9. The coextruded polymeric netting of claim 1, wherein there is at least one of a demarcation line between the first and second segments that is parallel to the segments or a demarcation line between the adhesive and the second segments.

10. The coextruded polymeric netting of claim 1, wherein the first segments comprise first material, the second segments comprise second material, and the adhesive comprises third material, wherein the first and second are the same material and different from the third material.

11. The polymeric coextruded netting of claim 1, wherein the first segments comprise first material, the second segments comprise second material, and the adhesive comprises third material, wherein the first, second, and third materials are different from each other.

12. The coextruded polymeric netting of claim 1, wherein there are at least 2.5 second segments per cm.

13. A fastener system comprising at least one coextruded polymeric netting of claim 1.

14. An article comprising first and second coextruded polymeric nettings of claim 1, wherein a portion of some of the second segments of the first coextruded polymeric netting are engaged between some of the adjacent second segments of the second coextruded polymeric netting.

15. The article of claim 14, wherein the engaged first and second coextruded polymeric nettings are the same netting.
